(19) United States
(12) Patent Application Publication
(10) Pub. No.: US 2010/0034124 A1
(43) Pub. Date: Feb. 11, 2010

(54) TETHERED DATA CALL WITH CONTINUOUS APPLICATION

(75) Inventors: Ajith Payyappilly, San Diego, CA (US); Lei Shen, Beijing (CN); Uppinder Singh Babbar, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/186,278

(22) Filed: Aug. 5, 2008

(51) Int. Cl. H04B 7/00

(52) U.S. Cl. 370/310

(57) ABSTRACT

Commonly, when a mobile device tethers to a computer, one Internet Protocol address is provided. When an embedded application runs continuously, such as with a Internet Protocol Multimedia Subsystem application, tethered applications can be prohibited from operating. If the continuous application is not active, then the continuous application can be disconnected and thus the tethered application can function.

### BACKGROUND

I. Field

The following description relates generally to wireless communications and, more particularly, to using enabling both tethered and embedded data calls.

II. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

MIMO systems commonly employ multiple (N_{T}) transmit antennas and multiple (N_{R}) receive antennas for data transmission. A MIMO channel formed by the N_{T} transmit and N_{R} receive antennas can be decomposed into N_{S} independent channels, which can be referred to as spatial channels, where N_{S}≦{N_{T}, N_{R}}. Each of the N_{S} independent channels corresponds to a dimension. Moreover, MIMO systems can provide improved performance (e.g., increased spectral efficiency, higher throughput and/or greater reliability) if the additional dimensionalities created by the multiple transmit and received antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region. However, conventional techniques can provide limited or no feedback related to channel information.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, there can be a method for regulating communication. The method can comprise determining an activity status for a continuous application. Moreover, the method can comprise facilitating a tethered data call based upon a determination that the activity status is dormant.

In a further aspect, a wireless communication apparatus can be implemented comprising an analyzer that determines an activity status for a continuous application as well as an enabler that facilitates a tethered data call based upon a determination that the activity status is dormant.

With another aspect, a wireless communications apparatus can be used that includes means for determining an activity status for a continuous application. The apparatus can also include means for facilitating a tethered data call based upon a determination that the activity status is dormant

In yet a further aspect, there can be a machine-readable medium having stored thereon machine-executable instructions for determining an activity status for a continuous application and facilitating a tethered data call based upon a determination that the activity status is dormant.

In one aspect, in a wireless communication system an apparatus can be used comprising a processor. The processor can be configured to determine an activity status for a continuous application. The processor can also be configured to facilitate a tethered data call based upon a determination that the activity status is dormant.

According to an aspect, there can be a method for regulating communication. The method can comprise recognizing a deregistering of a continuous application and facilitating a reregistering of the continuous application.

In a further aspect, a wireless communication apparatus can be used comprising a distinguisher that recognizes a deregistering of a continuous application and an assister that facilitates a reregistering of the continuous application.

With another aspect, there can be a wireless communications apparatus. The apparatus can comprise means for recognizing a deregistering of a continuous application as well as means for facilitating a reregistering of the continuous application.

In yet a further aspect, a machine-readable medium can be used having stored thereon machine-executable instructions. The instructions can be for recognizing a deregistering of a continuous application and facilitating a reregistering of the continuous application.

In one aspect, in a wireless communication system, there can be an apparatus comprising a processor. The processor can be configured to recognize a deregistering of a continuous application and facilitate a reregistering of the continuous application.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a communication system functioning with a tethered data call in conjunction with a continuously running application in accordance with various aspects set forth herein.

FIG. 3 is an illustration of a communication system functioning with a tethered data call in conjunction with a continuously running application with a detailed enabler in accordance with various aspects set forth herein.

FIG. 4 is an illustration of a communication system functioning with a tethered data call in conjunction with a continuously running application that can reconnect with a network in accordance with various aspects set forth herein.

FIG. 5 is an illustration of a communication system functioning with a tethered data call in conjunction with a continuously running application that can test an embedded data call in accordance with various aspects set forth herein.

FIG. 6 is an illustration of a methodology for facilitating a tethered data call in accordance with various aspects set forth herein.

FIG. 7 is an illustration of a methodology for network registration in accordance with various aspects set forth herein.

FIG. 8 is an illustration of a methodology for security measures in network registration in accordance with various aspects set forth herein.

FIG. 9 is an illustration of a first part of a data call regulation algorithm in accordance with various aspects set forth herein.

FIG. 10 is an illustration of a second part of a data call regulation algorithm in accordance with various aspects set forth herein.

FIG. 11 is an illustration of an example mobile device that facilitates tethered communication.

FIG. 12 is an illustration of an example system that facilitates tethered communication.

FIG. 13 is an illustration of an example wireless network environment that can be employed in conjunction with the various systems and methods described herein.

FIG. 14 is an illustration of an example system that facilitates operation of tethered communication regulation.

FIG. 15 is an illustration of an example system that facilitates network communication concerning tethered data calls.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It can be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

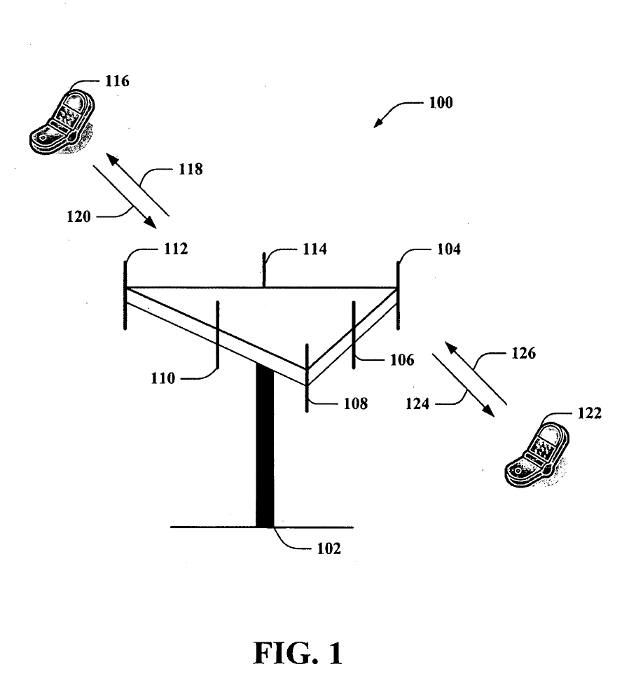

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

The set of antennas and/or the area in which they are designated to communicate can be referred to as a sector of base station 102. For example, multiple antennas can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. While disclosed for a CDMA (Code Division Multiple Access) standard, it is to be appreciated aspects disclosed herein can be used in a UMTS (Universal Mobile Telecommunications System) configuration.

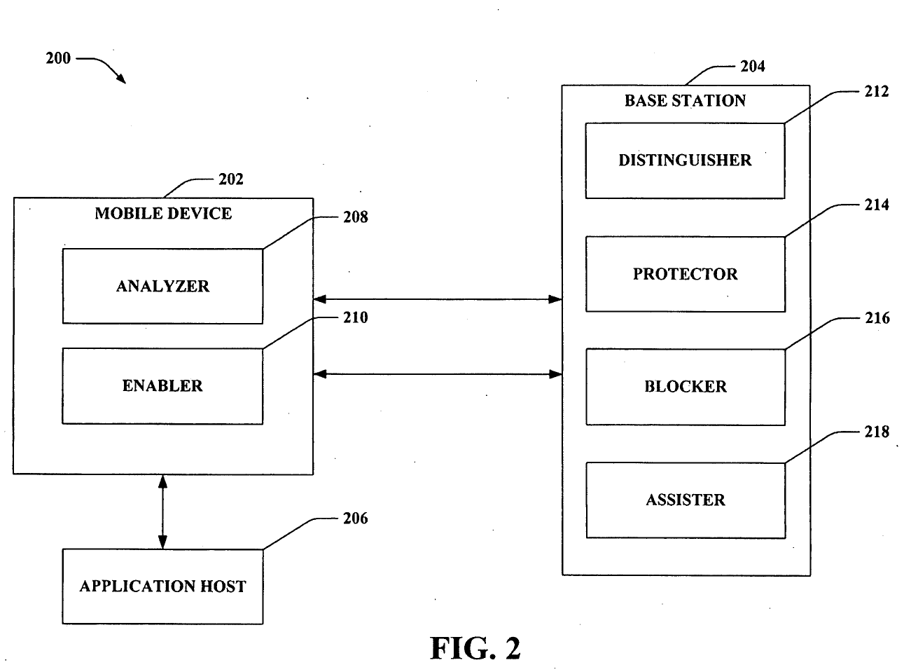

Referring now to FIG. 2, an example system 200 is disclosed for tethered call communication in conjunction with a continuous application (conventionally known as an ‘always-on’ application). A mobile device 202 can communicate with a base station 204 to engage in network communication, such as performing data calls. In one configuration, the mobile device 202 can operatively couple with an application host 206. The application host 206 can be computer, where the mobile device 202 functions as a modem and thus allows the application host to wirelessly communicate with other entities.

Two types of data calls that can be used in conjunction with the system 200 include embedded calls and tethered calls. An embedded data call can run on the mobile device 202 while a tethered data call operates upon the application host 206. In conventional operation, an embedded call and tethered call typically cannot coexist in some configurations, such as an Internet Protocol version 4 implementation. To complicate matters, some embedded data calls operate in conjunction with continuously running applications and as such do not allow for tethered data calls to function.

The system 200 can function to regulate data calls in a tethered configuration. A request to make a tethered data call can be obtained and an analyzer 208 can determine an activity status for a continuous application (e.g., determine an embedded ‘always-on’ application is active or dormant). According to one embodiment, continuous application is an Internet Protocol Multimedia Subsystem application. If the application is active, then the request can be denied; however, if the application is dormant, then an enabler 210 can facilitate a tethered data call.

The mobile device 202 can communicate with a base station 204 to facilitate operation of the data calls. When enabling a tethered data call, there can be deregistration from a network associated with the continuous application. A distinguisher 212 can recognize a deregistering (e.g., a request to deregister, a start of deregistration, etc.) of a continuous application (e.g., an Internet Protocol Multimedia Subsystem application).

There can be security concerns about deregistration and a protector 214 can be used to determine if the deregistration is authorized. A blocker 216 can function that prevents deregistration upon a determination that deregistration is unauthorized. However, if the deregistration is authorized, then the blocker 216 can allow deregistration to occur. Once the tethered data call is complete, a request to reregister can be collected and an assister 218 can operate that facilitates a reregistering of the continuous application.

The following is illustrative information for using in conjunction with aspects disclosed herein—this illustrative information is not intended to limit scope. Conventionally, there are two broad types of wireless data calls—tethered data calls and embedded data calls. Embedded data calls are commonly triggered by applications running on the MS (Mobile Station—the mobile device 202). Protocol suite (commonly referred to as TCP/IP) protocol stack software as well as CDMA (Code division multiple access) protocol stack software can operate upon the MS. In the case of tethered data calls, applications that trigger a data call can run on a personal computer (referred to as TE2, designated as application host 206), and the MS can function as a modem. The CDMA protocol stack software can run on the MS as in the case of embedded data calls and the TCP/IP protocol stack software can run on the TE2. The MS communicates with the base station 204 (BS) via a CDMA air-interface. The MS can be connected to the TE2 via a serial interface such as RS232 (Recommended Standard 232) or USB (Universal Serial Bus).

In Internet Protocol version 4, there is commonly assignment of one IP (Internet Protocol) address to the MS. The IP address can be used by the MS for doing embedded data calls or used by the TE2 for doing tethered data calls. Using Internet Protocol version 4 for an embedded and tethered data call, an embedded data call and a tethered data call cannot co-exist simultaneously. In Internet Protocol Multimedia Subsystem-enabled (IP Multimedia Subsystem) MS, when the MS is powered up, Internet Protocol Multimedia Subsystem software comes up, opens an embedded data call and sends SIP (Session Initiation Protocol) messages to register with the Internet Protocol Multimedia Subsystem core network.

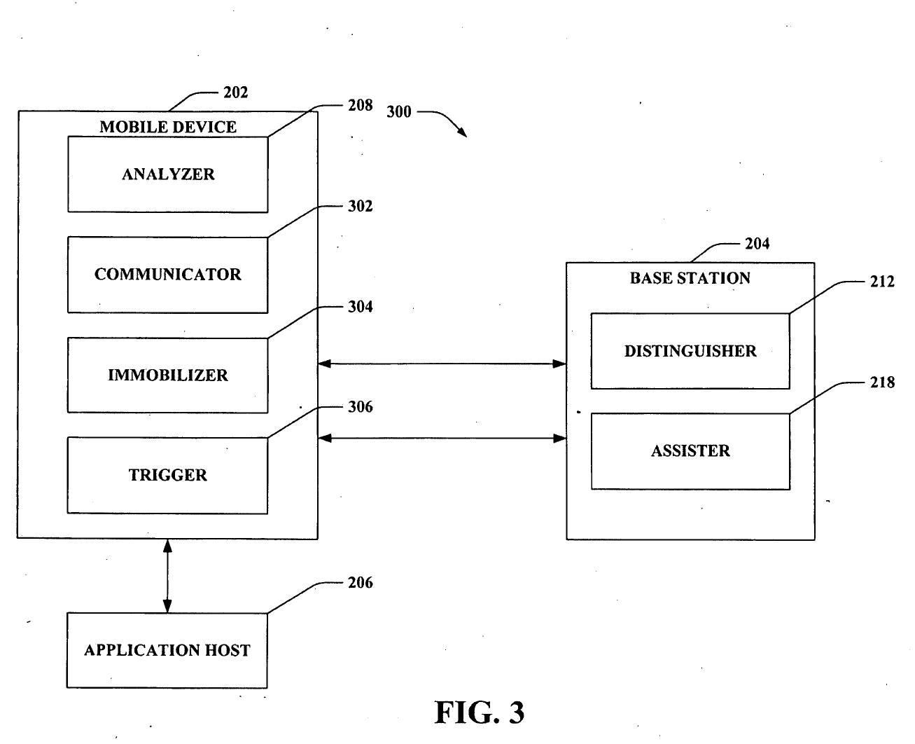

Referring now to FIG. 3, an example system 300 is disclosed for facilitating a tethered data call based upon a determination that an activity status is dormant (e.g., an ‘always-on’ application is not in use). A mobile device 202 can operatively couple to an application host 206 to conduct data calls through use of a base station 204. An embedded application can run upon the mobile device that conventionally blocks tethered data calls from running until the embedded application ends.

The mobile device 202 can use an analyzer 208 to determine an activity status of a continuous application. Depending on the activity status, a communicator 302 can deregister from a network of the continuous application. According to one embodiment, the communicator 302 retains metadata pertinent to reregistering at another time upon completion of a tethered data call, thus enabling quicker reregistration. In addition to deregistering from the call an immobilizer 304 can disable an embedded data call. Prior to disabling the embedded call and/or deregistering, the system 300 can ask for user conformation to protect from accidental deregistration or ending embedded data calls. A trigger 306 can activate the tethered data call one applicable. The trigger 306 can perform diagnostic tests to ensure that the tethered call can run (e.g., that the communicator 302 and/or immobilizer 304 correctly operate). It is to be appreciated that the communicator 302, immobilizer 304, and/or trigger 306 can implement as part of the enabler 210 of FIG. 2. The base station 204 can use a distinguisher 212 that recognizes a deregistering of a continuous application and an assister 218 that facilitates a reregistering of the continuous application.

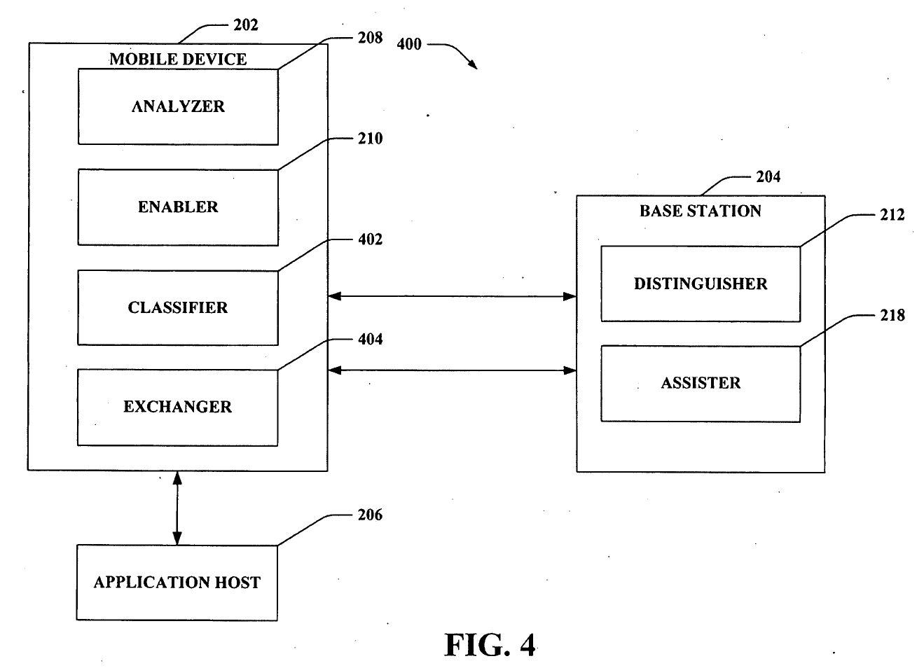

Referring now to FIG. 4, an example system 400 is disclosed for reregistering with a network, commonly after deregistration in order to use a tethered data call. A mobile device 202 can communicate with a network through a base station 204. Additionally, the mobile device 202 can operatively couple with an application host 206 such that the application host 206 can communicate with the network. The base station 204 can use a distinguisher 212 that recognizes a deregistering of a continuous application and/or an assister 218 that facilitates a reregistering of the continuous application.

An analyzer 208 can obtain a request to perform a tethered data call, collect metadata related to status of a continuous application, and evaluate the metadata to determine an activity status. If the activity status is dormant, then an enabler 210 can facilitate a tethered data call, such as by disabling an embedded data call. However, if the activity status is dormant, then the enabler 210 can reject a request to perform a tethered data call.

In a situation where the activity status is dormant, the enabler 210 can monitor operation of the tethered data call. Based upon this monitoring, a classifier 402 can recognize completion of the activated tethered data call. Examine monitoring can include passively observing use of the tethered data call, identifying tethered call metadata (e.g., an end command), actively requesting information that pertains to status of the tethered data call. Upon completion, an exchanger 404 can reregister to the network—commonly, the reregistering allows operation to be similar to operation prior to an embedded data call. Information retained by the communicator 302 of FIG. 2 can be employed to reregister. According to one embodiment, a user can be asked to confirm reregistration where reregistration does not occur without user authorization.

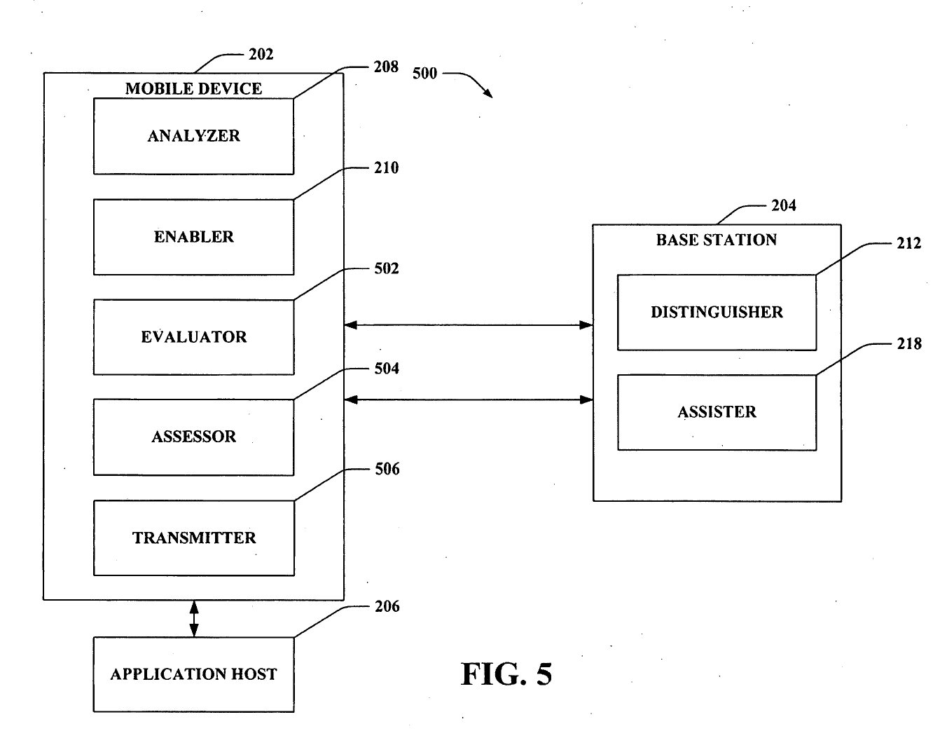

Referring now to FIG. 5, an example system 500 is disclosed for processing a data type session. A mobile device 202, base station 204, and application host 206 can communicate with one another to facilitate operation of data calls (e.g., tethered, embedded, and the like). The base station 204 can use a distinguisher 212 that recognizes a deregistering of a continuous application as well as an assister 218 that facilitates a reregistering of the continuous application.

Some data types can allow for operation of tethered and embedded data calls simultaneously. Therefore, the mobile device can employ an evaluator 502 that identifies a data session type, where determining an activity status occurs upon identification of a particular data session type. For example, with an Internet Protocol version 6 data type, the tethered data call can function automatically in conjunction with an embedded data call. An assessor 504 can determine if an enabled tethered call is successfully activated (e.g., if the enabler 210 is able to establish the tethered data call). If the assessor 504 determines the enabler 210 is unsuccessful, then the assessor 504 can send an instruction to the enabler 210 to make another attempt. After a certain number of attempts, the assessor 504 can determine the tethered call is likely not viable and instruct the exchanger 404 of FIG. 4 to operate.

Upon successful activation of an enabled tethered data call, a transmitter 506 can transfer a notice to terminal equipment that the tethered call is successfully activated. The transmitter 506 can determine what information is appropriate for the notice (e.g., based upon an intended recipient—such as secretive information having limited distribution). In addition, the transmitter 506 can collect feedback on operation of the mobile device 202 and/or base station 204 and alter operation based upon the feedback.

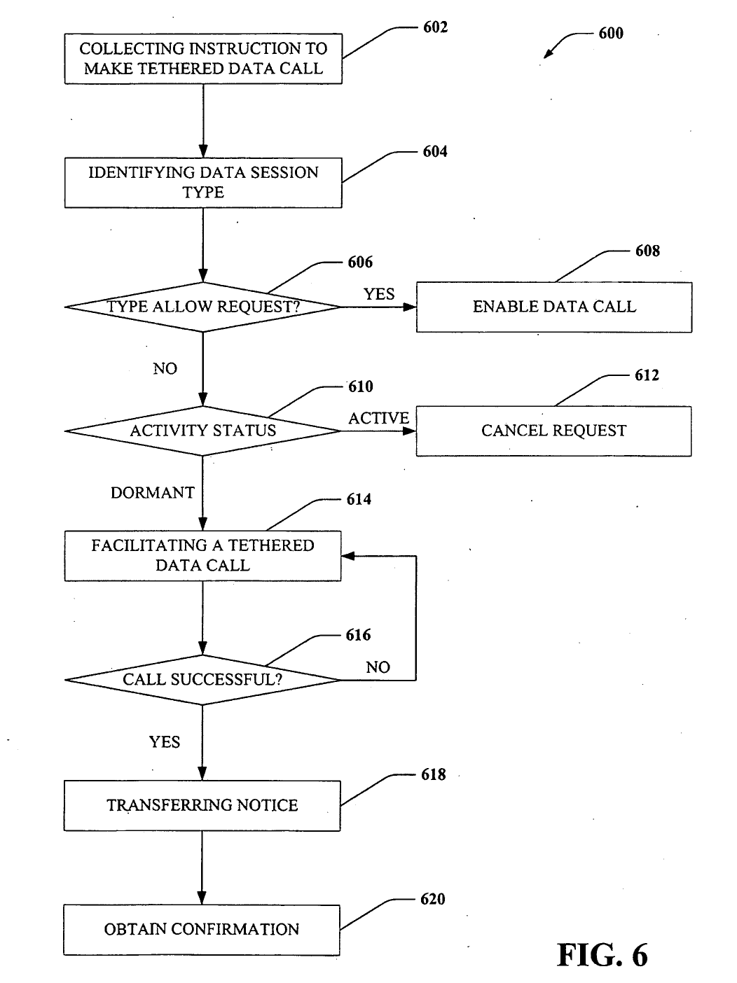

Referring to FIGS. 6-10, methodologies relating to mobile device communication are illustrated. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

Referring now to FIG. 6, an example methodology 600 is disclosed for processing a tethered data call, commonly concerning an Internet Protocol version 4 configuration. An instruction to operate a tethered data call can be collected at event 602 (e.g., originating from a user interaction with a graphical user interface). The instruction can initiate from a mobile device associated with the tethered call, an application host associated with the tethered call, a third-party device, etc.

A data session type can be identified at act 604 (e.g., Internet Protocol 4 version, Internet Protocol 6 version, and the like). A check 606 can be performed upon the identified type to determine if the request can be automatically allowed. For example, an Internet Protocol 6 version type can allow for embedded and tethered data calls at one time. Therefore, if appropriate, the instructed tethered data call can be automatically enabled at action 608.

If there cannot be automatic enabling, then the methodology 600 can continue to check 610 to determine an activity status of a continuous application. If the activity status is active, then the request to perform a tethered data call can be cancelled at action 612. According to an alternative embodiment, the tethered data call request can be placed in a wait situation if the check 610 determines the activity status is active. The check 610 can continuously operate and once a dormant status is identified, the methodology 600 can continue.

If the activity status is determined to be dormant, then there can be facilitating a tethered data call at action 614. A check 616 can operate to determine if the there is success in facilitating the tethered data call. If there is not success, then the methodology 600 can return to action 614 to make another attempt. After a set number of attempts, the methodology 600 can terminate (e.g., move to action 612). Upon successful implementation of the tethered data call, a notice can be transferred of the success at act 618 and confirmation can be obtained at event 620 on if the notice is successfully obtained.

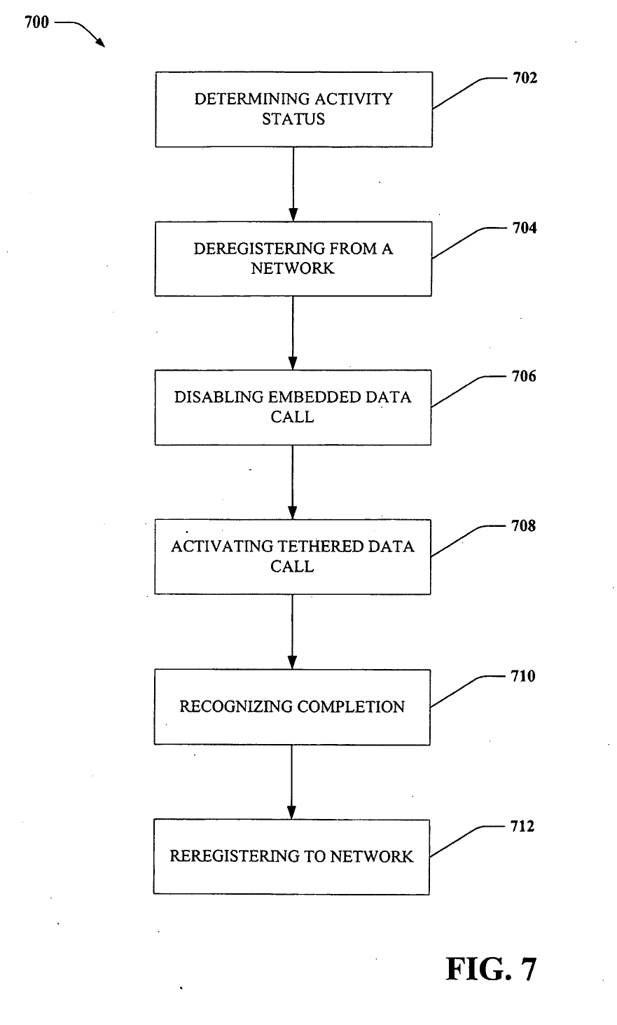

Referring now to FIG. 7, an example methodology 700 is disclosed for communication with a network in conjunction with operation of a tethered data call and embedded data call. At event 702, an activity status can be determined—commonly between active or dormant. However, it is to be appreciated that there can be determination of other activity status levels, such as engaging (e.g., start of an embedded data call), ending, and the like.

With an activity status designated as dormant, a tethered data call can be requested. Deregistration from a network can occur at action 704 (e.g., an Internet Protocol Multimedia Subsystem communication). In addition to network deregistration, there can be disabling an embedded data call at event 706. According to one embodiment, a user can be asked to confirm disablement of the embedded data call for operation to occur.

With a disabled embedded data call, a requested tethered data call can be activated at act 708. Once activated, checks can be run to determine if activation occurs in a desired manner (e.g., at a communication level requested by a user). The tethered data call can function and be monitored, where at least a part of the monitoring includes recognizing completion of the tethered data call at action 710. A check can be performed to determine if reregistration is appropriate—if appropriate, there can be reregistering to the network at event 712. While reregistration can restore communication to a status prior to action 704, it is to be appreciated that different configuration can be implemented.

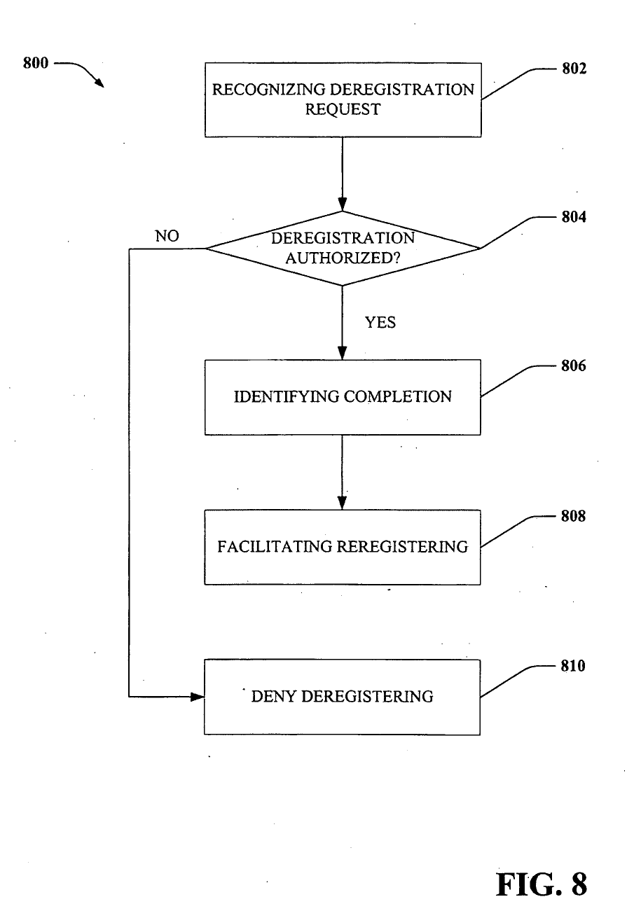

Referring now to FIG. 8, an example methodology 800 is disclosed for using security to protect network registration. A request to deregister a mobile device from a network can be recognized at action 802. In one implementation, deregistration can occur automatically upon a determination that a continuous application is not active as well as upon a request to perform a tethered data call.

A check 804 can be performed to determine if the request is authorized. According to one embodiment, a list of authorized users that can enable deregistration be retained (e.g., Internet Protocol addresses of authorized entities). A comparison can be made of a requester identity and the authorized list, where a result of the comparison is used to make the determination. Metadata associated with the request can be collected and analyzed to determine if a request is authorized.

If it is determined that the request is authorized, then a task (e.g., tethered data call) associated with the deregistration can be monitored. Commonly, reregistration can be desirable after a certain event, such as completion of a tethered data call. Completion of the tethered data call can occur at action 806 and reregistration can occur at act 808. In one configuration, diagnostics tests can occur to determine if reregistration is successful, meets expected parameters, and the like. If the check 804 determines that there is an unauthorized deregistration, then the request can be denied at act 810. While outright denial is possible, the methodology 800 can configure such that more information is requested to make an accurate determination.

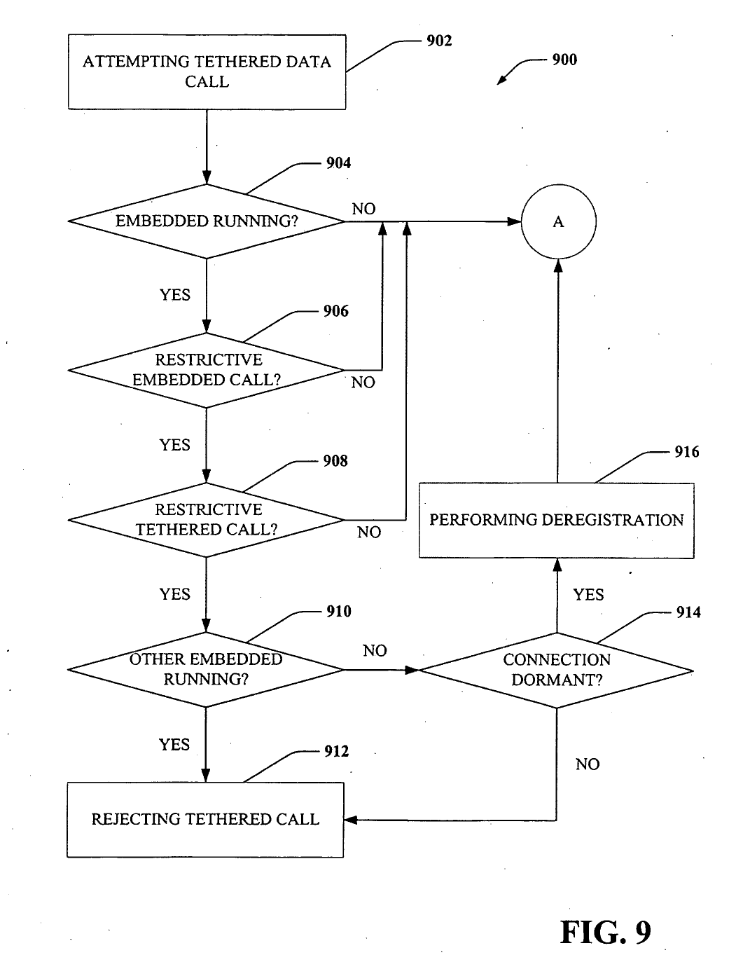

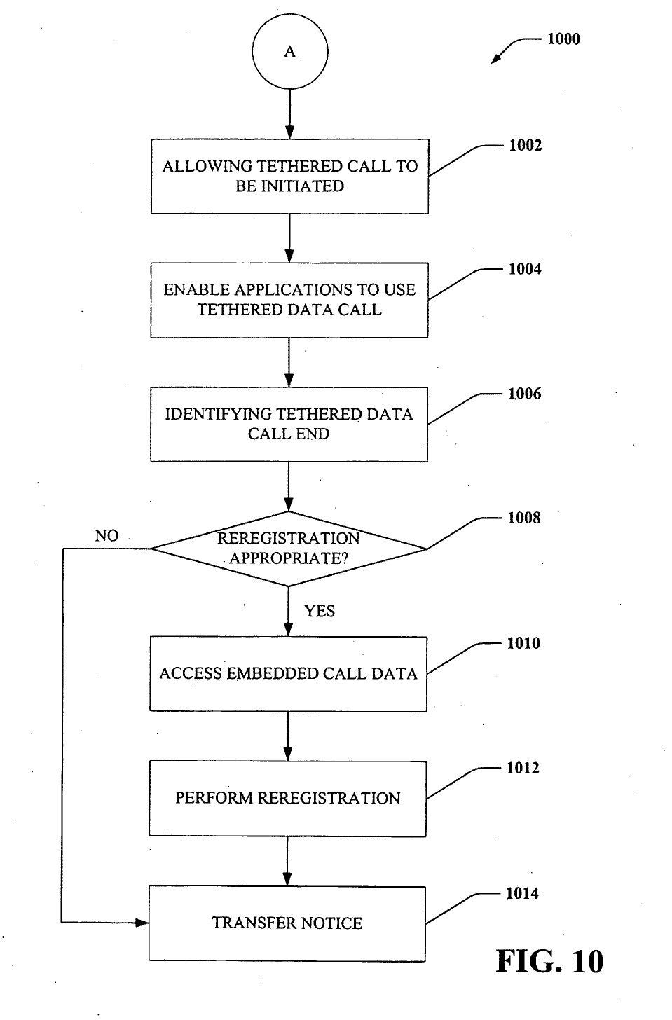

Referring now to FIG. 9 and FIG. 10, disclose a first part 900 and second part 1000 of a methodology for managing data calls upon a mobile device. An attempt can be made at action 902 to perform a tethered data call, commonly originating from a user command or an automatic generation device (e.g., a timer set to make a tethered call at a set time). With the attempt, at least one or more checks can operate to determine if the tethered call should be run.

A check 902 can run to determine if an embedded data call is running. If there is an embedded data call running, then a check 906 can determine if the call type is restrictive. For example, some call types can allow for embedded and tethered data calls simultaneously. If the embedded call type is restrictive, then another check 908 can run to determine if the attempted tethered data call is restrictive. If check 904, 906, or 908 result in a negative outcome, them the first part 900 of the methodology can continue to the second part 1000.

If the tethered call is also restrictive, then another check 910 can occur to determine if there is running embedded application are limited to continuous applications. If there are other embedded applications, then the tethered call can be rejected at action 912. If it is determined that there is one embedded application, then a check 914 can determine if a connection of the continuous application is active or dormant. If the application is active, then the tethered call can be rejected at action 912 or be placed in a wait mode. While in wait mode, the activity status is monitored for a change that can allow the methodology to continue. If the connection is dormant (e.g., initially, after waiting, etc.), then the continuous application can be deregistered at event 916 and the methodology can continue to the second part 1000.

At the second part 1000 of the methodology, there can be allowing the tethered call to be initiated at event 1002. The methodology can allow various applications to use the tethered data call at action 1004. Multiple applications can use the tethered data call at one time or applications can take turns using the tethered data call. Monitoring the tethered data call can allow for an end of a call to be identified at action 1006. The identification can occur through an active message being sent that a tethered data call is no longer appropriate, monitoring lack of use of the tethered data call, and the like.

A check 1008 can occur to determine if reregistration is appropriate (e.g., bring back registration undone at event 916 of FIG. 9). If it is determined that reregistration is appropriate, then a notification can be sent that registration is to occur again. Embedded call data can be accessed at action 1010 and reregistration can occur at act 1012. A notification can be transferred stating the reregistration is complete at action 1014.

Additionally, if reregistration is not appropriate, then a notice with this information can be transferred at action 1014. For example, the tethered data call can end based upon a loss of power to a mobile device and/or loss of power to an application host—without power, there can be no need and/or ability to perform reregistration. Additionally, feedback can be gathered on reregistration which can be used in other deregistration (e.g., collecting information that can be retained, such as appropriate addresses).

It will be appreciated that, in accordance with one or more aspects described herein, inferences can be made regarding mobile device communication, etc. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences pertaining to performing mobile device communication. By way of further illustration, an inference can be made related to selecting a number of physical frames as a wakeup period parameter based upon intended application, desired power savings, etc. It will be appreciated that the foregoing examples are illustrative in nature and are not intended to limit the number of inferences that can be made or the manner in which such inferences are made in conjunction with the various embodiments and/or methods described herein.

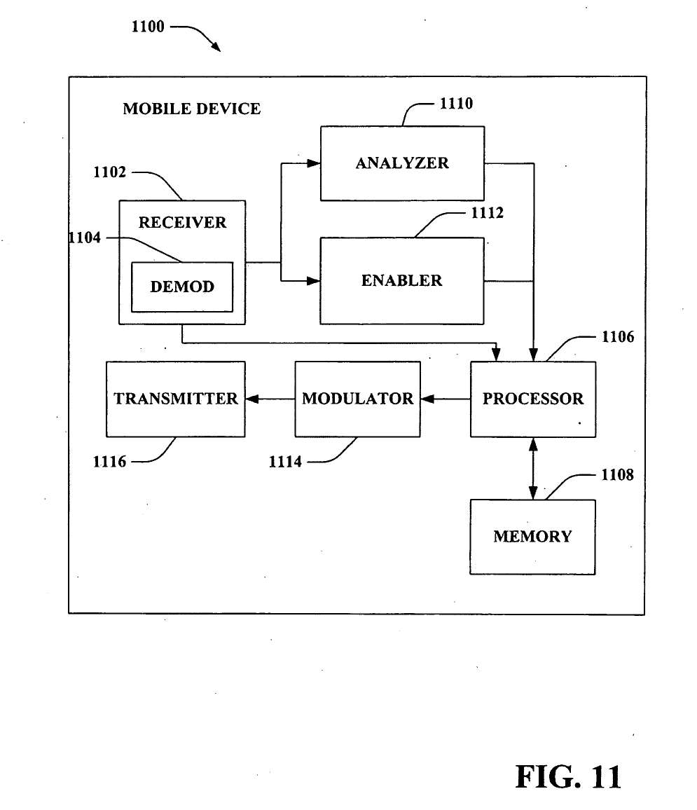

FIG. 11 is an illustration of a mobile device 1100 that facilitates mobile device communication. Mobile device 1100 comprises a receiver 1102 that receives a signal from, for instance, a receive antenna (not shown), and performs typical actions thereon (e.g., filters, amplifies, downconverts, etc.) the received signal and digitizes the conditioned signal to obtain samples. Receiver 1102 can be, for example, an MMSE receiver, and can comprise a demodulator 1104 that can demodulate received symbols and provide them to a processor 1106 for channel estimation. Processor 1106 can be a processor dedicated to analyzing information received by receiver 1102 and/or generating information for transmission by a transmitter 1116, a processor that controls one or more components of mobile device 1100, and/or a processor that both analyzes information received by receiver 1102, generates information for transmission by transmitter 1116, and controls one or more components of mobile device 1100.

Mobile device 1100 can additionally comprise memory 1108 that is operatively coupled to processor 1106 and that can store data to be transmitted, received data, information related to available channels, data associated with analyzed signal and/or interference strength, information related to an assigned channel, power, rate, or the like, and any other suitable information for estimating a channel and communicating via the channel. Memory 1108 can additionally store protocols and/or algorithms associated with estimating and/or utilizing a channel (e.g., performance based, capacity based, etc.).

It will be appreciated that the data store (e.g., memory 1108) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1108 of the subject systems and methods is intended to comprise, without being limited to, these and any other suitable types of memory.

Processor 1102 is further operatively coupled to an analyzer 1110 that determines an activity status for a continuous application and/or to an enabler 1112 that facilitates a tethered data call based upon a determination that the activity status is dormant. Mobile device 1100 still further comprises a modulator 1114 and a transmitter 1116 that transmits a signal (e.g., base CQI and differential CQI) to, for instance, a base station, another mobile device, etc. Although depicted as being separate from the processor 1106, it is to be appreciated that the analyzer 1110 and/or enabler 1112 can be part of processor 1106 or a number of processors (not shown).

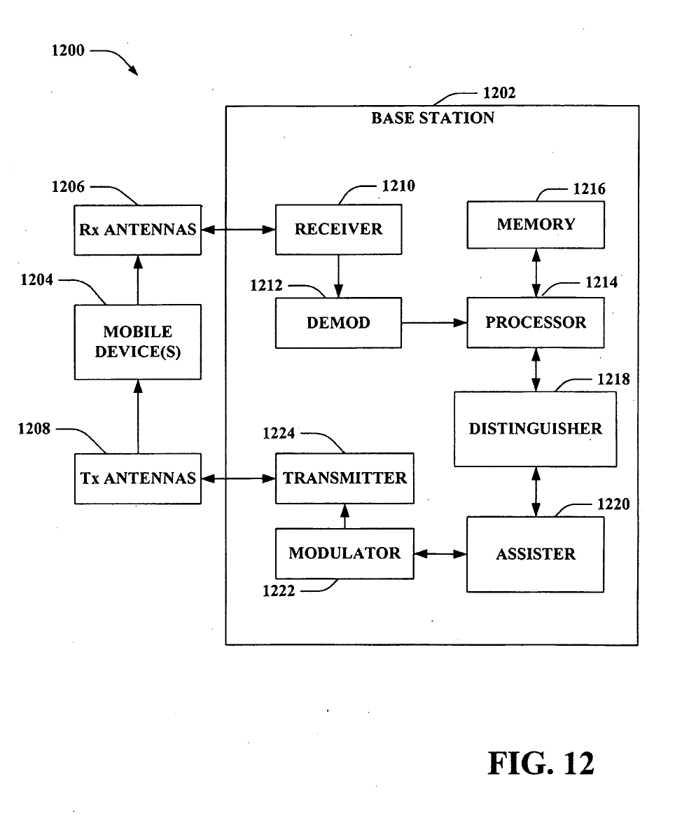

FIG. 12 is an illustration of a system 1200 that facilitates employing a tethered data call. System 1200 comprises a base station 1202 (e.g., access point, with a receiver 1210 that receives signal(s) from one or more mobile devices 1204 through a plurality of receive antennas 1206, and a transmitter 1222 that transmits to the one or more mobile devices 1204 through a plurality of transmit antennas 1208. Receiver 1210 can receive information from receive antennas 1206 and is operatively associated with a demodulator 1212 that demodulates received information. Demodulated symbols are analyzed by a processor 1214 that can be similar to the processor described above with regard to FIG. 11, and which is coupled to a memory 1216 that stores information related to estimating a signal (e.g., pilot) strength and/or interference strength, data to be transmitted to or received from mobile device(s) 1204 (or a disparate base station (not shown)), and/or any other suitable information related to performing the various actions and functions set forth herein.

Processor 1214 is further coupled to a distinguisher 1218 that recognizes a deregistering of a continuous application. Moreover, the processor 1214 can operatively couple to an assister 1220 that facilitates a reregistering of the continuous application. Further, processor 1214 can effectuate transmitting over the forward link channel to convey a FLAB message or an ARB message. Information to be transmitted can be provided to a modulator 1222. Modulator 1222 can multiplex the information for transmission by a transmitter 1226 through antenna 12012 to mobile device(s) 1204. Although depicted as being separate from the processor 1214, it is to be appreciated that the distinguisher 1218 and/or assister can be part of processor 1214 or a number of processors (not shown).

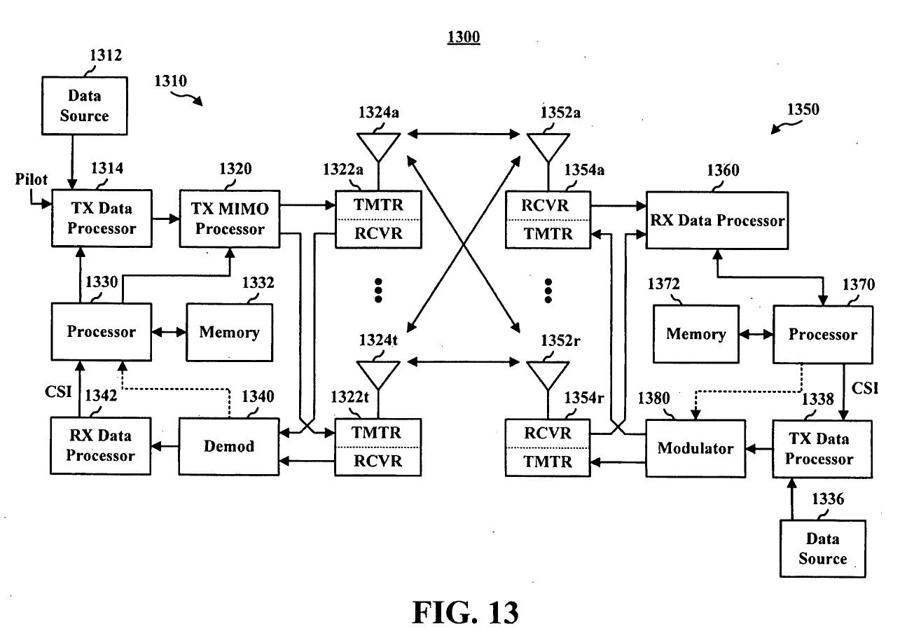

FIG. 13 shows an example wireless communication system 1300. The wireless communication system 1300 depicts one base station 1310 and one mobile device 1350 for sake of brevity. However, it is to be appreciated that system 1300 can include more than one base station and/or more than one mobile device, wherein additional base stations and/or mobile devices can be substantially similar or different from example base station 1310 and mobile device 1350 described below. In addition, it is to be appreciated that base station 1310 and/or mobile device 1350 can employ the systems (FIGS. 1-5 and 11-12) and/or methods (FIGS. 6-10) described herein to facilitate wireless communication there between.

At base station 1310, traffic data for a number of data streams is provided from a data source 1312 to a transmit (TX) data processor 1314. According to an example, each data stream can be transmitted over a respective antenna. TX data processor 1314 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1350 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1330.

The modulation symbols for the data streams can be provided to a TX MIMO processor 1320, which can further process the modulation symbols (e.g., for OFDM). TX MIMO processor 1320 then provides N_{T} modulation symbol streams to N_{T} transmitters (TMTR) 1322a through 1322t. In various embodiments, TX MIMO processor 1320 applies beamforming weights to the symbols of the data streams and to the antenna from which the symbol is being transmitted.

Each transmitter 1322 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1322a through 1322t are transmitted from N_{T} antennas 1324a through 1324t, respectively.

At mobile device 1350, the transmitted modulated signals are received by N_{R} antennas 1352a through 1352r and the received signal from each antenna 1352 is provided to a respective receiver (RCVR) 1354a through 1354r. Each receiver 1354 conditions (e.g., filters, amplifies, and downconverts) a respective signal, digitizes the conditioned signal to provide samples, and further processes the samples to provide a corresponding “received” symbol stream.

An RX data processor 1360 can receive and process the N_{R} received symbol streams from N_{R} receivers 1354 based on a particular receiver processing technique to provide N_{T} “detected” symbol streams. RX data processor 1360 can demodulate, deinterleave, and decode each detected symbol stream to recover the traffic data for the data stream. The processing by RX data processor 1360 is complementary to that performed by TX MIMO processor 1320 and TX data processor 1314 at base station 1310.

A processor 1370 can periodically determine which preceding matrix to utilize as discussed above. Further, processor 1370 can formulate a reverse link message comprising a matrix index portion and a rank value portion.

The reverse link message can comprise various types of information regarding the communication link and/or the received data stream. The reverse link message can be processed by a TX data processor 1338, which also receives traffic data for a number of data streams from a data source 1336, modulated by a modulator 1380, conditioned by transmitters 1354a through 1354r, and transmitted back to base station 1310.

At base station 1310, the modulated signals from mobile device 1350 are received by antennas 1324, conditioned by receivers 1322, demodulated by a demodulator 1340, and processed by a RX data processor 1342 to extract the reverse link message transmitted by mobile device 1350. Further, processor 1330 can process the extracted message to determine which preceding matrix to use for determining the beamforming weights.

Processors 1330 and 1370 can direct (e.g., control, coordinate, manage, etc.) operation at base station 1310 and mobile device 1350, respectively. Respective processors 1330 and 1370 can be associated with memory 1332 and 1372 that store program codes and data. Processors 1330 and 1370 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

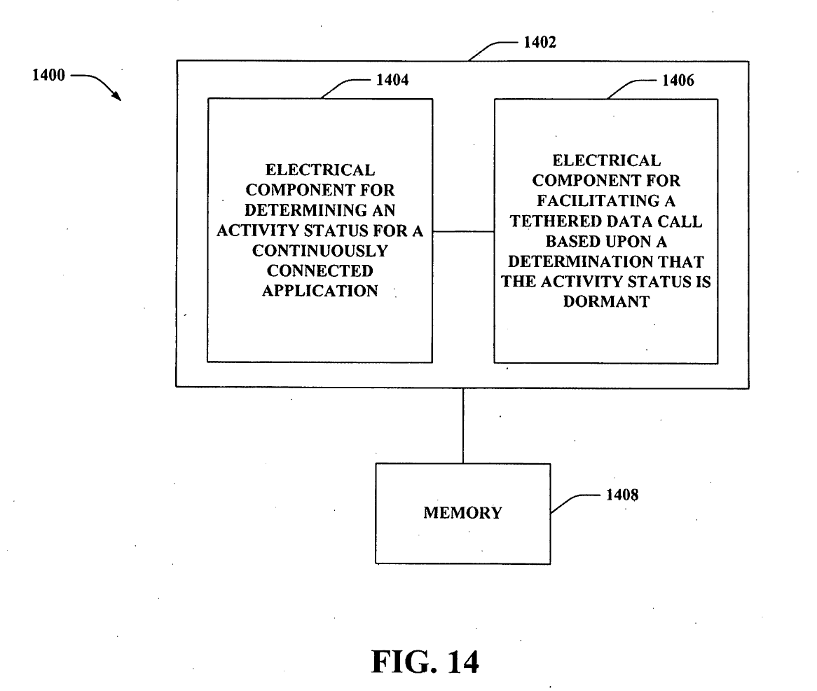

With reference to FIG. 14, illustrated is a system 1400 that effectuates tethered data call communication. For example, system 1400 can reside at least partially within a mobile device. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for determining an activity status for a continuous application 1404 as well as an electrical component for facilitating a tethered data call based upon a determination that the activity status is dormant 1406. The logical grouping 1402 can represent and include an electrical component for deregistering from a network of the continuous application, an electrical component for disabling an embedded data call, an electrical component for activating the tethered data call, an electrical component for recognizing completion of the activated tethered data call, an electrical component for reregistering to the network, an electrical component for identifying a data session type, an electrical component for determining an activity status functions upon identification of a particular data session type, an electrical component for determining if an enabled tethered call is successfully activated, an electrical component for transferring a notice to terminal equipment that the tethered call is successfully activated, or a combination thereof. Additionally, system 1400 can include a memory 1408 that retains instructions for executing functions associated with electrical components 1404 and 1406. While shown as being external to memory 1408, it is to be understood that one or more of electrical components 1404 and 1406 can exist within memory 1408.

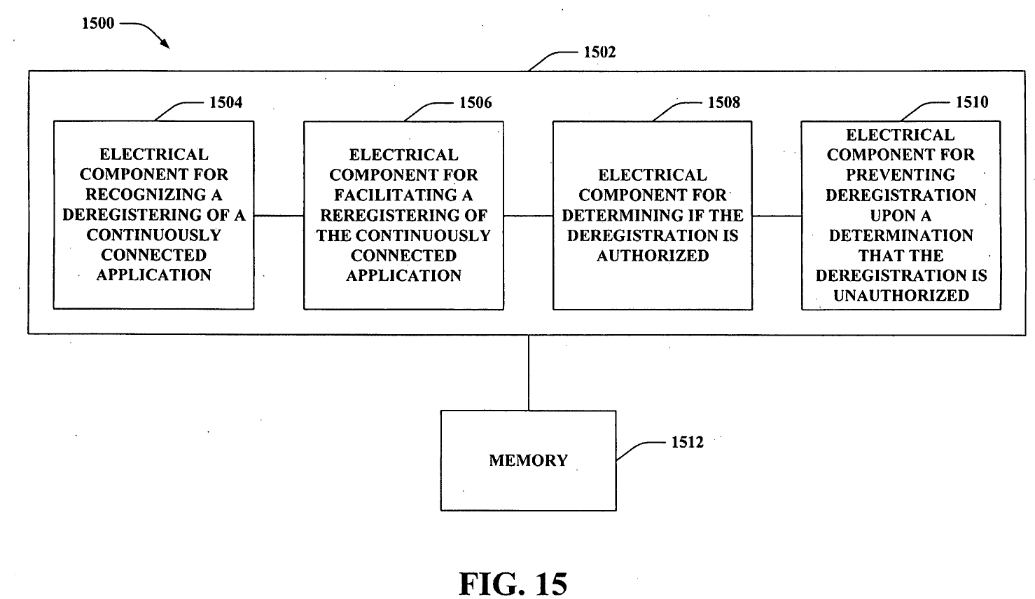

Turning to FIG. 15, illustrated is a system 1500 that calculates reduced feedback by employing successive interference operations on permuted codewords. System 1500 can reside within a base station, for instance. As depicted, system 1500 includes functional blocks that can represent functions implemented by a processor, software, or combination thereof (e.g. firmware). System 1500 includes a logical grouping 1502 of electrical components that facilitate controlling forward link transmission. The logical grouping 1502 can include an electrical component for recognizing a deregistering of a continuous application 1504. Moreover, the logical grouping 1502 can include an electrical component for facilitating a reregistering of the continuous application 1506. Moreover, a electrical component for determining if the deregistration is authorized 1508 and an electrical component for preventing deregistration upon a determination that the deregistration is unauthorized 1510 can be part of the logical grouping 1502. Additionally, system 1500 can include a memory 1512 that retains instructions for executing functions associated with electrical components 1504, 1506, 1508, and 1510. While shown as being external to memory 1512, it is to be understood that electrical components 1504, 1506, 1508 and 1510 can exist within memory 1512.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for regulating communication, comprising:
determining an activity status for a continuous application; and
facilitating a tethered data call based upon a determination that the activity status is dormant.

2. The method of claim 1, the continuous application is an Internet Protocol Multimedia Subsystem application.

3. The method of claim 1, facilitating the tethered data call comprises:
deregistering from a network of the continuous application;
disabling an embedded data call; and
activating the tethered data call.

4. The method of claim 3, further comprising:
recognizing completion of the activated tethered data call; and
reregistering to the network.

5. The method of claim 1, further comprising identifying a data session type, determining an activity status occurs upon identification of a particular data session type.

6. The method of claim 5, the particular data session type is an Internet Protocol version 4 data type.

7. The method of claim 1, further comprising determining if an enabled tethered call is successfully activated.

8. The method of claim 7, further comprising transferring a notice to terminal equipment that the tethered call is successfully activated.

9. A wireless communication apparatus, comprising:
an analyzer that determines an activity status for a continuous application; and
an enabler that facilitates a tethered data call based upon a determination that the activity status is dormant.

10. The apparatus of claim 8, the continuous application is an Internet Protocol Multimedia Subsystem application.

11. The apparatus of claim 8, the enabler comprises:
a communicator that deregisters from a network of the continuous application;
an immobilizer that disables an embedded data call; and
a trigger that activates the tethered data call.

12. The apparatus of claim 11, further comprising:
a classifier that recognizes completion of the activated tethered data call; and
an exchanger that reregisters to the network.

13. The apparatus of claim 8, further comprising an evaluator that identifies a data session type, determining an activity status occurs upon identification of a particular data session type.

14. The apparatus of claim 13, the particular data session type is an Internet Protocol version 4 data type.

15. The apparatus of claim 8, further comprising an assessor that determines if an enabled tethered call is successfully activated.

16. The apparatus of claim 15, further comprising a transmitter that transfers a notice to terminal equipment that the tethered call is successfully activated.

17. A wireless communications apparatus, comprising:
means for determining an activity status for a continuous application; and
means for facilitating a tethered data call based upon a determination that the activity status is dormant.

18. The apparatus of claim 17, the continuous application is an Internet Protocol Multimedia Subsystem application.

19. The apparatus of claim 17, facilitating the tethered data call comprises:
means for deregistering from a network of the continuous application;
means for disabling an embedded data call; and
means for activating the tethered data call.

20. The apparatus of claim 19, further comprising:
means for recognizing completion of the activated tethered data call; and
means for reregistering to the network.

21. The apparatus of claim 17, further comprising means for identifying a data session type, means for determining an activity status functions upon identification of a particular data session type.

22. The apparatus of claim 21, the particular data session type is an Internet Protocol version 4 data type.

23. The apparatus of claim 17, further comprising means for determining if an enabled tethered call is successfully activated.

24. The apparatus of claim 23, further comprising means for transferring a notice to terminal equipment that the tethered call is successfully activated.

25. A machine-readable medium having stored thereon machine-executable instructions for:
determining an activity status for a continuous application; and
facilitating a tethered data call based upon a determination that the activity status is dormant.

26. The machine-readable medium of claim 25, the continuous application is an Internet Protocol Multimedia Subsystem application.

27. The machine-readable medium of claim 25, facilitating the tethered data call comprises:
deregistering from a network of the continuous application;
disabling an embedded data call; and
activating the tethered data call.

28. The machine-readable medium of claim 27 having stored thereon machine-executable instructions for:
recognizing completion of the activated tethered data call; and
reregistering to the network.

29. The machine-readable medium of claim 25 having stored thereon machine-executable instructions for identifying a data session type, determining an activity status occurs upon identification of a particular data session type.

30. The machine-readable medium of claim 29, the particular data session type is an Internet Protocol version 4 data type.

31. The machine-readable medium of claim 25 having stored thereon machine-executable instructions for determining if an enabled tethered call is successfully activated.

32. The machine-readable medium of claim 31 having stored thereon machine-executable instructions for transferring a notice to terminal equipment that the tethered call is successfully activated.

33. In a wireless communication system, an apparatus comprising:
a processor configured to:
determine an activity status for a continuous application; and
facilitate a tethered data call based upon a determination that the activity status is dormant.

34. The apparatus of claim 33, the continuous application is an Internet Protocol Multimedia Subsystem application.

35. The apparatus of claim 33, facilitating the tethered data call comprises:
deregistering from a network of the continuous application;
disabling an embedded data call; and
activating the tethered data call.

36. The apparatus of claim 35, the processor is further configured to:
recognize completion of the activated tethered data call; and
reregister to the network.

37. The apparatus of claim 33, the processor is further configured to identify a data session type, determining an activity status occurs upon identification of a particular data session type.

38. The apparatus of claim 37, the particular data session type is an Internet Protocol version 4 data type.

39. The apparatus of claim 33, the processor is further configured to determine if an enabled tethered call is successfully activated.

40. The apparatus of claim 39, the processor is further configured to transfer a notice to terminal equipment that the tethered call is successfully activated.

41. A method for regulating communication, comprising:
recognizing a deregistering of a continuous application; and
facilitating a reregistering of the continuous application.

42. The method of claim 41, the continuous application is an Internet Protocol Multimedia Subsystem application.

43. The method of claim 41, further comprising determining if the deregistration is authorized.

44. The method of claim 43, further comprising preventing deregistration upon a determination that the deregistration is unauthorized.

45. A wireless communication apparatus, comprising:
a distinguisher that recognizes a deregistering of a continuous application; and
an assister that facilitates a reregistering of the continuous application.

46. The apparatus of claim 45, the continuous application is an Internet Protocol Multimedia Subsystem application.

47. The apparatus of claim 45, further comprising a protector that determines if the deregistration is authorized.

48. The apparatus of claim 47, further comprising a blocker that prevents deregistration upon a determination that the deregistration is unauthorized.

49. A wireless communications apparatus, comprising:
means for recognizing a deregistering of a continuous application; and
means for facilitating a reregistering of the continuous application.

50. The apparatus of claim 49, the continuous application is an Internet Protocol Multimedia Subsystem application.

51. The apparatus of claim 49, further comprising means for determining if the deregistration is authorized.

52. The apparatus of claim 51, further comprising means for preventing deregistration upon a determination that the deregistration is unauthorized.

53. A machine-readable medium having stored thereon machine-executable instructions for:
recognizing a deregistering of a continuous application; and
facilitating a reregistering of the continuous application.

54. The machine-readable medium of claim 53, the continuous application is an Internet Protocol Multimedia Subsystem application.

55. The machine-readable medium of claim 53 having stored thereon machine-executable instructions for determining if the deregistration is authorized.

56. The machine-readable medium of claim 55 having stored thereon machine-executable instructions for preventing deregistration upon a determination that the deregistration is unauthorized.

57. In a wireless communication system, an apparatus comprising:
a processor configured to:
recognizing a deregistering of a continuous application; and
facilitating a reregistering of the continuous application.

58. The apparatus of claim 57, the continuous application is an Internet Protocol Multimedia Subsystem application.

59. The apparatus of claim 57, the processor is further configured to determining if the deregistration is authorized.

60. The apparatus of claim 59, the processor is further configured to preventing deregistration upon a determination that the deregistration is unauthorized.
